(19) United States
(12) Patent Application Publication
(10) Pub. No.: US 2004/0056447 A1
(43) Pub. Date: Mar. 25, 2004

(54) Bicycle front forked shake-proof elastic device

(76) Inventor: Bill Huang, ChangHua (TW)

Correspondence Address: Bill Huang, 235 Chung-Ho, Box 8-24, Taipei, TW

(21) Appl. No.: 10/252,929

(22) Filed: Sep. 24, 2002

(51) Int. Cl. B62K 25/08

(52) U.S. Cl. 280/276

(57) ABSTRACT

A bicycle front forked shake-proof elastic device comprises a forked body, two inner tubes, two outer tubes and two shake-proof units. The forked body has a stand tube. The two inner tubes are inserted into the two outer tubes. Each of the two shake-proof units are placed between an inner tube an outer tube, respectively. A bottom of each inner tube is formed with a reduced section; an outer surface of the reduced section is formed with a plurality of buckling rings. The shake-proof unit includes a shake-proof spring, a positioning block and a stud. A top end of the positioning block is a small diameter section with a plurality of buckling rings. The two ends of the shake-proof spring are engaged to the buckling rings the inner tube and the positioning block. A stud inserts into the via hole from the closing end of the outer tube.

### FIELD OF THE INVENTION

The present invention relates to components of bicycles; and particularly to a bicycle front forked shake-proof elastic device which can be assembled easily and made with a lower cost.

### BACKGROUND OF THE INVENTION

Referring to FIG. 1, a prior art bicycle front forked device includes two inner tubes 1′, two outer tubes 2′, and a shake-proof unit 3′. A lower end of each outer tube 2′ is a seal end 22′ which has a screw hole 21′. The shake-proof unit 3′ includes an upper stopper 31′, a guide rod 32′, a shake-proof spring 33′ and a lower stopper 34′. A top of the guide rod 32 is formed with a head 321′ having a hexagonal hole therein and the lower end thereof has a threaded section 322′ with a proper length. The guide rod 32′ is inserted into the upper stopper 31′, the shake-proof spring 33′ and the lower stopper 34′, sequentially so that the upper and lower ends of the shake-proof spring 33′ resists against the upper and lower stoppers 31′ and 34′. Thereby, the head 32′ of the guide rod 32 is positioned at the top of the upper stopper 31′. The upper stopper 31′ is placed within and buckled in the lower end of the inner tube 1′. The inner tube 1′ is inserted into the outer tube 2′ so that the head of the threaded section 322′ is at a position with respect to the screw hole 21′ of the close end 22′ of the outer tube 2′. A hexagonal spanner is inserted into the hexagonal hole in the head 321′ of the guide rod 32′ from a top of the inner tube 1′. Rotating the hexagonal spanner, the threaded section 322′ at the lower end of the guide rod 32′ is screwed with the screw hole 21′ of the closed end 22′ of the outer tube 2.

In this prior art structure, the shake-proof spring 33′ has the following disadvantages in assembly.

1. The shake-proof spring 33′ must match with the upper stopper 31′, the lower stopper 34′ and the guide rod 32′. The structure is complex and the cost is high. Moreover, in assembly, the upper stopper 31′ and the lower end of the inner tube 1′ must be buckled and thus the assembly work is difficult.

2. In screwing the lower end of the guide rod 32′ with the closing end 22′ at the lower end of the outer tube 2′, the hexagonal spanner must be inserted into the inner tube 1′ for rotating the guide rod 32′. Since the rod of the spanner must be long, the operation is difficult. Moreover, the lower end of the inner tube 1′ is sealed by the upper stopper 31′. Thereby, only weak light can incident into the inner tube 1′, but the inserted spanner will further shield the light. Thereby, it is difficult to align the inserted spanner with the head 321′ of the guide rod 32′. The bicycle front forked device is difficult in assembly and cost for assembling the device is high.

### SUMMARY OF THE INVENTION

Accordingly, the primary object of the present invention is to provide a bicycle front forked shake-proof elastic device comprising a forked body, two inner tubes, two outer tubes and two shake-proof units. The forked body has a stand tube. A lower end of the stand tube is firmly secured with a transversal seat. The two inner tubes are in parallel and inserted into the two outer tubes; each of the two shake-proof units are placed between an inner tube an outer tube, respectively.

A bottom of each inner tube is formed with a reduced section. An outer surface of the reduced section is formed with a plurality of buckling rings. A lower end of each outer tube is a closed end which has a via hole. The shake-proof unit includes a shake-proof spring, positioning block and a stud. A top end of the positioning block is a small diameter section with a plurality of buckling rings. A center portion of the positioning block is formed with a longitudinal screw hole. A top and a lower ends of the shake-proof spring are engaged to the buckling ring of the reduced section of the inner tube and the buckling ring at the top end of the positioning block. A stud inserts into the via hole from the closing end of the outer tube to screw with the longitudinal screw hole of the positioning block.

By above structure, the present invention has a preferred structure and the assembled work can be positioned rapidly so that the labor and cost are greatly reduced.

The various objects and advantages of the present invention will be more readily understood from the following detailed description when read in conjunction with the appended drawing.

### BRIEF DESCRIPTION OF THE DRAWINGS

FIG. 1 is a cross section view of a prior art bicycle front forked shake-proof elastic device.

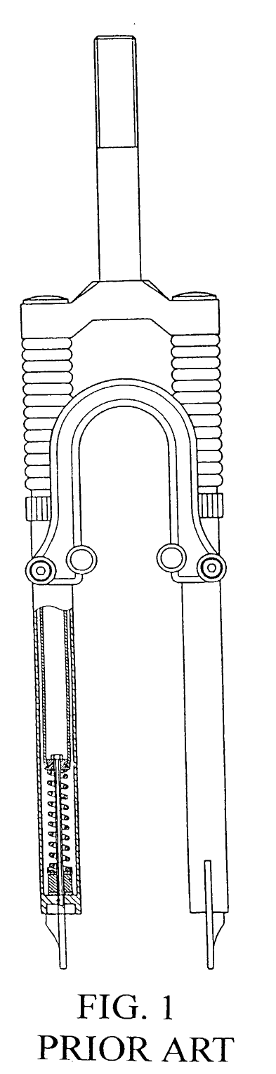

FIG. 2 is a perspective view of the present invention.

FIG. 3 is an exploded perspective view of the present invention.

FIG. 4 is a schematic cross sectional view of the present invention.

### DETAILED DESCRIPTION OF THE PREFERRED EMBODIMENTS

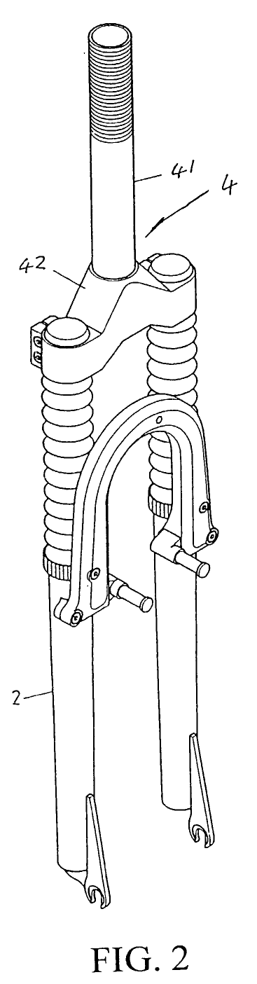

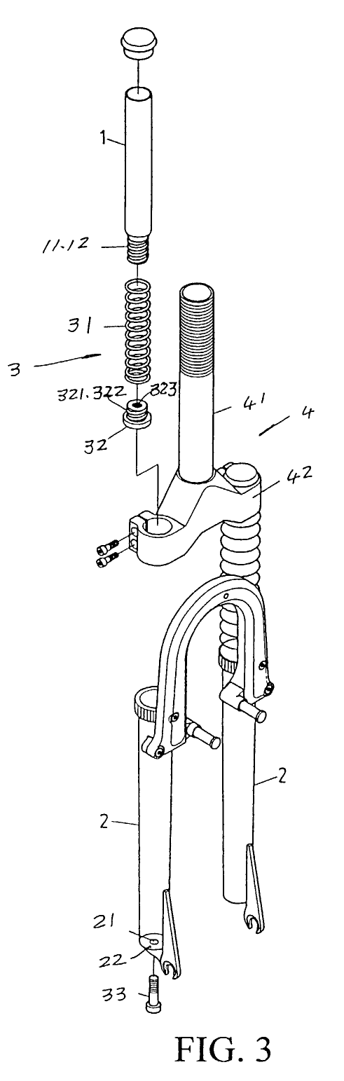

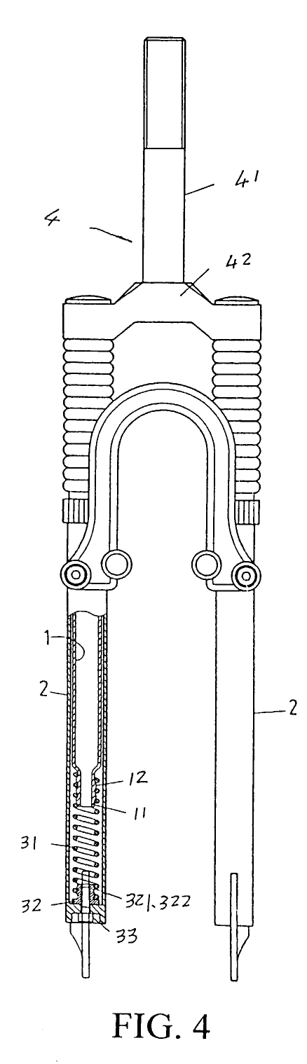

Referring to FIGS. 2, 3 and 4, the bicycle front forked shake-proof elastic device of the present invention is illustrated. The bicycle front forked shake-proof elastic device includes a forked body 4, two inner tubes 1, two outer tubes 2 and two shake-proof units 3. The forked body 4 has a stand tube 41. The lower end of the stand tube 41 is firmly secured with a transversal seat 42. A bottom of each inner tube 1 is formed with a reduced section 11. The outer surface of the reduced section 11 is formed with a plurality of buckling rings 12. A lower end of each outer tube 2 is a closed end 22 which has a via hole 21. The shake-proof unit 3 includes a shake-proof spring 31, a positioning block 32 and a stud 33. A top end 321 of the positioning block 32 is a small diameter section with a plurality of buckling rings 322. The center portion of the positioning block 32 is formed with a longitudinal screw hole 323. A top and a lower ends of the shake-proof spring 31 are engaged to the buckling ring 12 of the reduced section 11 of the inner tube 1 and the buckling ring 322 at the top end 321 of the positioning block 32. The two inner tubes 1 are firmly secured to the two sides of the transversal seat 42 and then are inserted into the outer tubes 2. The two shake-proof units 3 are placed between the inner tubes 1 and the outer tubes 2. The stud 33 inserts into the via hole 21 from the closing end 22 of the outer tube 2 to screw with the longitudinal screw hole 323 of the positioning block 32. By above structure, the present invention has a preferred structure and the assembled work can be positioned rapidly so that the labor and cost are greatly reduced.

In summary, the present invention has the following advantages:

1. The inner tubes 1 are formed integrally. A lower end of the inner tube 1 is integrally formed with a reduced section 11. An outer wall of the reduced section is integrally formed with a buckling ring 12. Thereby, the manufacturing of the inner tube 1 is easy. The cost is reduced greatly. Moreover, the shake-proof spring 31 is only necessary to be connected to the reduced section 11 of the inner tube 1 and the positioning block 32. Thus, the present invention can be assembled simple.

2. No guide tube is installed in the present invention. Only screw 33 is inserted into the outer tube 2 from the via hole 21 at the lower end of the outer tube 2 to the longitudinal screw hole 323 of the positioning block 32. Thereby, the assembly work is easy, no special spanner or other tool is necessary. Moreover, since the stud 33 enters into the screw hole 323 of the positioning block 32 through the via hole 21 from outer portion of the lower end of the outer tube 2 and the positioning block 32 resists against the lower end of the outer tube 2. The longitudinal screw hole 323 is communicated with the via hole 21 at the lower end of the outer tube 2 and thus the stud 33 passes into the positioning block 32 for being positioned therein. Thus the shake-proof spring 31 can be assembled rapidly and easily. Thereby, the labor and cost are reduced greatly.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A bicycle front forked shake-proof elastic device; comprising a forked body, two inner tubes, two outer tubes and two shake-proof units; the forked body having a stand tube; a lower end of the stand tube is firmly secured with a transversal seat; the two inner tubes being in parallel and inserted into the two outer tubes; each of the two shake-proof units being placed between an inner tube and an outer tube, respectively, characterized in that:
a bottom of each inner tube is formed with a reduced section; an outer surface of the reduced section is formed with a plurality of buckling rings; a lower end of each outer tube is a closed end which has a via hole; the shake-proof unit includes a shake-proof spring, a positioning block and a stud; a top end of the positioning block is a small diameter section with a plurality of buckling rings; a center portion of the positioning block is formed with a longitudinal screw hole; a top and a lower ends of the shake-proof spring are engaged to the buckling ring of the reduced section of the inner tube and the buckling ring at a top end of the positioning block; a stud inserts into the via hole from the closing end of the outer tube to screw with the longitudinal screw hole of the positioning block.
